(19) United States
(12) Patent Application Publication
(10) Pub. No.: US 2005/0271790 A1
(43) Pub. Date: Dec. 8, 2005

(54) Reduced fat shortening, roll-in, and spreads using citrus fiber ingredients

(75) Inventors: Greg Aronson, Bloomington, MA (US); Brock M. Lundberg, Roberts, WI (US); Dale Lindquist, Willmar, MN (US)

Correspondence Address: Mark A. Litman & Associates, P.A.;York Business Center, Suite 205, 3209 West 76th St., Edina, MN, 55435, US

(73) Assignee: Fiberstar, Inc.

(21) Appl. No.: 11/165,430

(22) Filed: Jun. 23, 2005

Related U.S. Application Data
(63) Continuation-in-part of application No. 10/969,805, filed on Oct. 20, 2004.
Application No. 10/969,805 is a continuation-in-part of application No. 10/288,793, filed on Nov. 6, 2002.

(51) Int. Cl. A23D 7/00

(52) U.S. Cl. 426/601

(57) ABSTRACT

A composition of matter is used as an ingredient in cooking comprising 1-30% by weight of highly refined cellulose fiber, 20-85% by weight animal consumable oils or fats and 5-40% by weight of water. The product can replace shortenings and fats and oils, and can be used in baked, fried, extruded and frozen products. A highly refined cellulosic materials (e.g., cellulose, modified celluloses, derivatized celluloses, hemicellulose, lignin, etc.) product can be prepared by generally moderate treatment and still provide properties that are equivalent to or improved upon the properties of the best highly refined cellulose products produced from more intense and environmentally unfriendly processes. Fruit or vegetable cells with an exclusively parenchymal cell wall structure can be treated with a generally mild process to form highly absorbent microfibers.

### RELATED APPLICATIONS DATA

This application is a continuation-in-part of U.S. patent application Ser. No. 10/969,805, filed 20 Oct. 2004, and titled “HIGHLY REFINED CELLULOSIC MATERIALS COMBINED WITH HYDROCOLLOIDS,” which is a continuation-in-part of U.S. patent application Ser. No. 10/288,793, filed Nov. 6, 2002, titled “HIGHLY REFINED FIBER MASS, PROCESS OF THEIR MANUFACTURE AND PRODUCTS CONTAINING THE FIBERS.”

### BACKGROUND OF THE INVENTION

1. Field of the Invention

The present invention relates to the field of additives to flour-containing products, such as baked or deep-fried goods for human or other animal consumption, particularly additives that can reduce the fat content of such flour products while maintaining perceived taste and sensory quality in the flour-containing product.

2. Background of the Art

Published articles from FDA, American Heart Association, and Harvard all tie a link between trans fats and saturated fats with increased LDL (bad cholesterol) and thus, heart disease. Beginning in January 2006, FDA will require food companies to list the amount of trans fatty acids on their labels. To lower the trans fat levels in foods, shortening suppliers have introduced low trans fat shortenings. However, within the newer compositions that have been provided for low trans shortenings there is an increase in the amount of saturated fats. In a typical shortening the saturated fat goes from 26% in standard shortening to 40% in low trans shortenings. Therefore, while shortening suppliers are trying to offer a healthier product a product with lower the trans fat, there is a trade-off with the increased saturated fats that raises concerns with regard to the saturated fat ingredient. For companies concerned about keeping trans fats off their labels, a company that switches to a low trans/higher saturated fat shortening for certain high fat products, e.g. cakes, donuts, etc, will still need to label an amount of trans fatty acids and also indicate a higher level of saturated fats.

U.S. Pat. Nos. 6,251,458; 5,487,419; 4,923,981; 4,831,127; 4,629,575, Weibel) relates to material additives. U.S. Pat. No. 4,923,981 relates more to issues of fat replacement describes using expanded parenchymal cell cellulose (PCC) for fat reduction. However, this Weibel patent specifically talks about making PCC through a process that uses alkaline or acid conditions. Additionally, the patent does not give a method for drying the product nor enable using a dried and expanded PCC, whereas the product used in the present technology is in a dried form.

U.S. Pat. No. 5,964,983 (Dinand) uses alkaline and/or acid conditions to make their microfibrillated cellulose. Dinand discloses the use of alkaline and/or acid conditions to make microfibrillated cellulose, and also does not disclose the combination of water, fiber and shortening directly together to make a reduced fat shortening, oil, margarine, or butter.

U.S. Pat. No. 5,766,662 (Inglett) describes replacing fat, but specifically states that the fat replacement product is the product made according to his invention is a product made through the combination of mechanical and chemical processes. Additionally, the dry product he makes needs to be sheared in a shearing device, i.e., a high speed blender, before the product can be used for fat replacement. This work does not disclose the direct combination of water, fiber, and shortening together to make a reduced fat shortening, oil, margarine, or butter.

In considering the Weibel patents (U.S. Pat. Nos. 6,251,458; 5,487,419; 4,923,981; 4,831,127; and 4,629,575), only U.S. Pat. No. 4,923,981 appears to have relevant disclosure with respect to fat replacement using expanded parenchymal cell cellulose (PCC) for fat reduction. The resulting product is not a reduced fat shortening, spread, roll-in, butter, or oil, but is a compounded product. Additionally, this patent specifically talks about making PCC through a process that uses alkaline or acid conditions. Weibel also does not give a method for drying fiber, which is a very significant and important step in the process of providing a highly refined cellulose fiber, and especially a highly refined cellulose fiber from citrus pulp and material with high parenchymal content. Weibel does not disclose using a dried and expanded PCC

Several other prior art sources (US patent #'s: U.S. Pat. Nos. 5,658,609, 5,190,776, 5,360,627, 5,439,697, 6,048,564) state the concept of a reduced fat shortening, margarine, spread, roll-in, butter, or oil but they are made with either combinations of modified starches, gums, emulsifiers, or combinations of other ingredients as opposed to the object of this invention is to do the fat reduction using an expanded cell wall cellulose and water.

### SUMMARY OF THE INVENTION

A composition of matter is used as an ingredient in cooking comprising 1-30% by weight of highly refined cellulose fiber, 20-85% by weight animal consumable oils or fats and 5-40% by weight of water. The product can replace shortenings and fats and oils, and can be used in baked, fried, extruded and frozen products.

### DETAILED DESCRIPTION OF THE INVENTION

A highly refined cellulosic materials (e.g., cellulose, modified celluloses, derivatized celluloses, hemicellulose, lignin, etc.) product can be prepared by generally moderate treatment and still provide properties that are equivalent to or improved upon the properties of the best highly refined cellulose products produced from more intense and environmentally unfriendly processes. Fruit or vegetable cells with an exclusively parenchymal cell wall structure can be treated with a generally mild process to form highly absorbent microfibers. Cells from citrus fruit and sugar beets are particularly available in large volumes to allow volume processing to generate highly refined cellulose fibers with both unique and improved properties. These exclusively parenchymal microfibers (hereinafter referred to as EPM's) have improved moisture retention and thickening properties that enable the fibers to provide unique benefits when combined into edible products (e.g., baked goods, liquefied foods, whipped foods, meats, meat fillers, dairy products, yogurt, frozen food entrees, ice cream, etc.) and in mixtures that can be used to generate edible food products (e.g., baking ingredients, dehydrated or low hydration products).

A new process for making HRC cellulose from parenchyma cell wall products, e.g. citrus fruit and sugar beets by-products, is performed in the absence of a hydroxide soaking step. This is a significant advance over the prior art as described by the Chen and Lundberg patents. Dinand, et al. (U.S. Pat. No. 5,964,983) also recommends the use of a chemical treatment step in addition to bleaching. In the present invention we are able to attain higher functionality (measured as viscosity) compared to Dinand et al. even though we use less chemical treatment, which is likely due to the higher amount of shear and chemical energy we put into the materials. The product is able to display the same or improved water retention properties and physical properties of the more strenuously refined agricultural products of the prior art, and in some cases can provide even higher water retention values, thickening and other properties that can produce unique benefits in particular fields of use.

General descriptions of the invention include a highly refined cellulose product comprising microfibers derived from organic fiber plant mass comprising at least 50% by weight of all fiber mass as parenchymal fiber mass, the highly refined cellulose product having an alkaline water retention capacity of at least about 25 g H₂O/g dry highly refined cellulose product and methods for providing and using these products. The highly refined cellulose product may have a water retention capacity of at least 50 g H₂O/g dry highly refined cellulose product.

Parenchymal cell walls refer to the soft or succulent tissue, which is the most abundant cell wall type in edible plants. For instance, in sugar beets, the parenchyma cells are the most abundant tissue the surrounds the secondary vascular tissues (xylem and phloem). Parenchymal cell walls contain relatively thin cell walls compared to secondary cell walls are tied together by pectin (Haard and Chism, 1996, Food Chemistry. Ed. By Fennema. Marcel Dekker NY, N.Y.) In secondary cell walls (xylem and phloem tissues), the cell walls are much thicker than parenchymal cells and are linked together with lignin (Smook). This terminology is well understood in the art.

As used in the practice of the present invention, the term “dry” or “dry product” refers to a mass that contains less than 15% by weight of fibers as water. The organic fiber mass comprises at least 50% by weight of fiber mass from organic products selected from the group consisting of sugar beets, citrus fruit, grapes, tomatoes, chicory, potatoes, pineapple, apple, carrots and cranberries. A food product or food additive may have at least 0.05 percent by weight solids in the food product or food additive of the above described highly refined cellulose product. The food product may also have at least about one percent or at least about two percent by weight of the highly refined cellulosic fiber of the invention.

A method for refining cellulosic material may comprise:
soaking raw material from organic fiber plant mass comprising at least 50% by weight of all fiber mass as parenchymal fiber mass in an aqueous solution with less than 1% NaOH;
draining the raw material and allowing the raw material to sit for a sufficient period under conditions (including ambient conditions of room temperature and pressure as well as accelerated conditions) so that the fibers and cells are softened so that shearing can open up the fibers to at least 40%, at least 50%, at least 60%, or at least 70, 80, 90 or 95% of their theoretic potential. This will usually require more that 4 hours soaking to attain this range of their theoretic potential. It is preferred that this soaking is for more than 5 hours, and preferably for at least about 6 hours. This soaking time is critical to get the materials to fully soften. When such a low alkaline concentration is used in the soaking, without the set time, the materials do not completely soften and can not be sheared/opened up to their full potential. This process produces soaked raw materials; and the process continues with refining the soaked raw material to produce refined material; and drying the soaked raw material.

The process may perform drying by many different commercial methods, although some display improved performance in the practice of the present invention. It is preferred that drying is performed, at least in part, by fluid bed drying or flash drying or a combination of the two. An alternative drying process or another associated drying step is performed at least in part by tray drying. For example, fluid bed drying may be performed by adding a first stream of organic fiber plant mass and a second stream of organic fiber plant mass into the drier, the first stream having a moisture content that is at least 10% less than the moisture content of the second stream or organic fiber plant mass. The use of greater differences in moisture content (e.g., at least 15%, at least 20%, at least 25%, at least 40%, at least 50% weight-to-weight water percent or weight-to-weight water-to-solid percent) is also within the scope of practice of the invention. In the drying method, the water may be extracted with an organic solvent prior to drying. In the two stream drying process, the second stream of organic fiber plant mass may have at least 25% water to solids content and the first stream may have less than 15% water to solids content. These processes may be practiced as batch or continuous processes. The method may use chopping and washing of the cellulose mass prior to soaking.

Another description of a useful process according to the invention may include draining and washing the soaked raw material in wash water to produce washed material; bleaching the washed material in hydrogen peroxide to produce a bleached material; and washing and filtering the bleached material to produce a filtered material.

The drying of an expanded fiber material according to the invention may use room temperature or higher air temperatures that dry the expanded fiber product and maintain the fiber material's functionalities of at least two characteristics of surface area, hydrogen bonding, water holding capacity and viscosity. It is also useful to use backmixing or evaporating to bring the organic fiber plant mass to a solids/water ratio that will fluidize in air in a fluid bed air dryer. This can be particularly performed with a method that uses a fluid bed dryer or flash dryer to dry the expanded or highly refined cellulosic fiber product.

The use of a flash or fluid bed dryer is an advantage over the drying methods suggested by Dinand et al. We have found that through the use of a fluid bed or flash dryer, low temperatures and controlled humidity are not needed to dry the materials of the present invention. In fact, although nearly any drying temperature in the fluid bed or flash dryer can be used, we have dried the product of the present invention using high air temperatures (400 F) and attained a dry product with near equivalent functional properties after rehydration compared to the materials before drying. Additionally, using the process of the present invention, any surface area expanded cellulosic product can be dried and a functional product obtained and is not limited to parenchyma cell wall materials. The use of a fluid bed or flash dryer, the use of relatively high drying air temperatures (400 F+), and the ability to dry non parenchyma cell wall (secondary cell) and obtain a functional product is in great contrast to the relatively low temperatures, e.g. 100 C (212 F) and dryer types taught by Dinand et al to dry expanded parenchymal cell wall materials.

The University of Minnesota patent application (Lundberg et al), describes the ability to obtain a functional dried product. However, the only way they were able to obtain a functional dry product was through freeze drying (Gu et al, 2001).—from (Gu, L., R Ruan, P. Chen, W. Wilcke, P. Addis. 2001. Structure Function Relationships of Highly Refined Cellulose. Transactions of the ASAE. Vol 44(6):1707-1712). Freeze drying is not an economically feasible drying operation for large volumes of expanded cell wall products.

The fiber products of the invention may be rehydrated or partially rehydrated so that the highly refined cellulose product is rehydrated to a level of less than 90 g H₂O/g fiber mass, 70 g H₂O/g fiber mass, 50 g H₂O/g fiber mass or rehydrated to a level of less than 30 g H₂O/g fiber mass or less than 20 g H₂O/g fiber mass. This rehydration process adjusts the functionalities of the product within a target range of at least one property selected from the group consisting of water holding capacity, oil holding capacity, and viscosity and may include the use of a high shear mixer to rapidly disperse organic fiber plant mass materials in a solution. Also the method may include rehydration with soaking of the dry materials in a solution with or without gentle agitation.

Preferred areas of use include a bakery product to which at least 1% by weight of the organic fiber product of the invention is present in the bakery product. The process may enhance the stability of a bakery product by adding at least 1% by weight of the product of claim to the bakery product, usually in a range of from 1% to 10% by weight of the organic fiber plant mass product to the bakery product prior to baking and then baking the bakery product. This process may include increasing the storage stability of a flour-based bakery product comprising adding from 1% to 10% by weight of the highly refined organic fiber plant mass product 1 to the bakery product prior to baking and then baking the bakery product.

The basic process of the invention may be generally described as providing novel and improved fiber waste by-product from citrus fruit pulp (not the wood and stem and leaves of the trees or plant, but from the fruit, both pulp and skin) or fiber from sugar beet, tomatoes, chicory, potatoes, pineapple, apple, cranberries, grapes, carrots and the like (also exclusive of the stems, and leaves). The provided fiber mass is then optionally soaked in water or aqueous solution (preferably in the absence of sufficient metal or metallic hydroxides e.g., KOH, CaOH, LiOH and NaOH) as would raised the pH to above 9.5, preferably in the complete absence of such hydroxides (definitely less than 3.0%, less than 1.0%, more often less than 0.9%, less than 0.7%, less than 0.5%, less than 0.3%, less than 0.1%). The soaked material is then drained and optionally washed with water. This is optionally followed by a bleaching step (any bleaching agent may be used, but mild bleaching agents that will not destroy the entire physical structure of the fiber material is to be used (with hydrogen peroxide a preferred example, as well as mild chlorine bleaches). It has also been found that the bleach step is optional, but that some products require less color content and require bleaching. The (optionally) bleached material is washed and filtered before optionally being subjected to a shredding machine, such as a plate refiner which shreds the material into micro fibers. The optionally soaked, bleached, and refined material is then optionally dispersed, and homogenized at high pressure to produce HRC gel.

The HRC dispersion of the present invention is a highly viscous, semi-translucent gel. HRC embodiments comprise dried powders that are redispersable in water to form gel-like solutions. The functional characteristics of HRC are related to various properties, including water- and oil-retention capacity, average pore size, and surface area. These properties inherently relate to absorption characteristics, but the properties and benefits provided by the processes and products of the invention seem to relate to additional properties created in the practice of the invention.

The present invention also includes an aqueous HRC gel having a lignin concentration of about one to twenty percent (1 to 20%). The HRC products of the present invention exhibit a surprisingly high WRC in the range of about 20 to at least about 56 g H₂O/g dry HRC. This high WRC is at least as good as, and in some cases, better than the WRC of prior art products having lower or the same lignin concentrations. The HRC products exhibit some good properties for ORC (oil retention capacity).

A general starting point for a process according to the invention is to start with raw material of sufficiently small size to be processed in the initial apparatus (e.g., where soaking or washing is effected), such as a soaker or vat. The by-product may be provided directly as a result of prior processing (e.g., juice removal, sugar removal, betaine removal, or other processing that results in the fiber by-product. The process of the present invention may also begin when raw material is reduced in size (e.g., chopped, shredded, pulverized) into pieces less than or equal to about 10×5 cm or 5 cm×2 cm. Any conventional type of manual or automated size reduction apparatus (such as chopper, shredder, cutter, slicer, etc.) can be used, such as a knife or a larger commercially-sized chopper. The resulting sized raw material is then washed and drained, thus removing dirt and unwanted foreign materials. The washed and chopped raw material is then soaked. The bath is kept at a temperature of about 20 to 100° C. The temperature is maintained within this range in order to soften the material. In one embodiment, about 100 g of chopped raw material is soaked in a 2.5 liter bath within a temperature range of about 20 to 80 degrees Centigrade for 10 to 90 minutes.

The resulting soaked raw material is subjected to another washing and draining. This washing and additional washing and draining tend to be more meaningful for sugar beets, potatoes, carrots (and to some degree also tomatoes, chicory, apple, pineapple, cranberries, grapes, and the like) than for citrus material. This is because sugar beets, potatoes, carrots, growing on the ground rather than being supported in bushes and trees as are citrus products, tend to pick up more materials from the soil in which they grow. Sugar beets and carrots tend to have more persistent coloring materials (dyes, pigments, minerals, oxalates, etc.) and retained flavor that also are often desired to be removed depending upon their ultimate use. In one embodiment, the soaked raw material is washed with tap water. In one other embodiment, the material is drained. This is optionally followed by bleaching the material with hydrogen peroxide at concentrations of about one (1) to 20% (dry basis) peroxide. The bleaching step is not functionally necessary to effect the citrus and grape fiber conversion to highly refined cellulose. With respect to carrots and sugar beets, some chemical processing may be desirable, although this processing may be significantly less stressful on the fiber than the bleaching used on corn-based HRC products. From our experience, some chemical step is required for sugar beets, and bleaching is one option. Using alkaline pretreatment baths is another option. Acid treatment or another bleaching agent are other options.

The material is optionally bleached at about 20 to 100° C. for about five (5) to 200 min. The bleached material is then subjected to washing with water, followed by filtering with a screen. The screen can be any suitable size. In one embodiment, the screen has a mesh size of about 30 to 200 microns.

The filtered material containing solids can then be refined (e.g., in a plate refiner, stone mill, hammer mill, ball mill, or extruder.). In one embodiment, the filtered material entering the refiner (e.g., a plate refiner) contains about four percent (4%) solids. In another embodiment, the refining can take place in the absence of water being added. The plate refiner effectively shreds the particles to create microfibers. The plate refiner, which is also called a disk mill, comprises a main body with two ridged steel plates for grinding materials. One plate, a refining plate, is rotated while a second plate remains stationary. The plates define grooves that aid in grinding. One plate refiner is manufactured by Sprout Waldron of Muncy, Pa. and is Model 12-ICP. This plate refiner has a 60 horsepower motor that operates at 1775 rpm.

Water may be fed into the refiner to assist in keeping the solids flowing without plugging. Water assists in preventing the refiner's plates from overheating, which causes materials in the refiner to burn. (This is a concern regardless of the type of grinding or shearing device used.). The distance between the plates is adjustable on the refiner. To set refining plate distances, a numbered dial was affixed to the refining plate adjustment handle. The distance between the plates was measured with a micrometer, and the corresponding number on the dial was recorded. Several plate distances were evaluated and the setting number was recorded. A variety of flow consistencies were used in the refiner, which was adjusted by varying solids feed rate. The amount of water flowing through the refiner remained constant. Samples were sent through the refiner multiple times. In one embodiment the materials are passed one or more times through the plate refiner.

The microfibers may then be separated with a centrifuge to produce refined materials. The refined materials are then diluted in water until the solids content is about 0.5 to 37%. This material is then dispersed. In one embodiment, dispersing continues until a substantially uniform suspension is obtained, about 2 to 10 minutes. The uniform suspension reduces the likelihood of plugging.

The resulting dispersed refined materials, i.e., microparticles, may then be homogenized in any known high pressure homogenizer operating at a suitable pressure. In one embodiment, pressures greater than about 5,000 psi are used. The resulting highly refined cellulose (HRC) gel may display a lignin content of about 1 to 20% by weight, depending in part upon its original content.

The absence of use of a mild NaOH soaking before the refining step in the present invention prior to high pressure homogenization does not require the use of high temperature and high pressure cooking (high temperature means a temperature above 100 degrees C. and high pressure means a pressure above 14 psi absolute). High temperature and high pressure cooking may be used, but to the disadvantage of both economics and output of the product. This novel process further avoids the need for either mild concentrations of NaOH or of highly concentrated NaOH and the associated undesirable environmental impact of discharging waste water containing any amount of NaOH and organic compounds. The process also avoids a need for an extensive recovery system. In one embodiment, the pH of the discharge stream in the present invention is only about 8 to 9 and may even approach 7. The method of the present invention has the further advantage of reducing water usage significantly over prior art processes, using only about one third to one-half the amount of water as is used in conventional processes to produce to produce HRC gel and amounts even less than that used in the Chen processes

All of the mechanical operations, refining, centrifuging, dispersing, and homogenizing could be viewed as optional, especially in the case of citrus pulp or other tree bearing fruit pulps. Additionally, other shearing operations can be used, such as an extruder, stone mill, ball mill, hammer mill, etc. For citrus pulp, the only processes that are needed to produce the expanded cell structure are to dry (using the novel drying process) and then properly hydrate the raw material prior to the expanding and shearing step of the process of the invention. This simple process could also be used in other raw material sources.

Hydration is a term that means reconstituting the dried fiber back to a hydrated state so that it has functionality similar to the pre-dried material. Hydration can be obtained using various means. For instance, hydration can occur instantly by placing the dry products in a solution followed by shearing the mixture. Examples of shearing devices are a high shear disperser, homogenizer, blender, ball mill, extruder, or stone mill. Another means to hydrate the dry materials is to put the dry product in a solution and mix the materials for a period of time using gentle or minimal agitation. Hydrating dry materials prior to use in a recipe can also be conducted on other insoluble fibrous materials to enhance their functionality.

The initial slurry of fibers/cells from the EPM products is difficult to dry. There is even disclosure in the art (e.g., U.S. Pat. No. 4,413,017 and U.S. Pat. No. 4,232,049) that slurries of such processed products cannot be easily dried without expensive and time consuming processes (such as freeze drying, extended flat bed drying, and the like). Freeze drying is effective, but is not economically and/or commercially desirable. Similarly, tray dryers may be used, but the length of time, labor and energy requirements make the process costly. The slurries of the citrus and/or beet by-products may be dried economically and effectively according to the following practices of the invention. Any type of convective drying method can be used, including a flash dryer, fluid bed dryer, spray dryer, etc. One example of a dryer that can be used is a fluid bed dryer, with dry material being added to the slurry to equilibrate the moisture content in the materials. It has been found that by adding 5:1 to 1:1 dry to wet materials within the fluid bed drier improves the air flow within the drier and the material may be effectively dried. In the absence of the combination of “dry” and “wet” materials, the slurry will tend to merely allow air to bubble through the mass, without effective drying and without a true fluid bed flow in the drier. The terms wet and dry are, of course, somewhat relative, but can be generally regarded as wet having at least (>40% water/<60% solid content] and dry material having less than 20% water/80% solid content). The amounts are not as critical as the impact that the proportional amounts of materials and their respective water contents have in enabling fluid flow within the fluid bed drier. These ranges are estimates. It is always possible to use “wet” material with lower moisture content, but that would have to have been obtained by an earlier drying or other water removal process. For purpose of economy, and not for enabling manufacture of HRC microfibers according to the present invention from citrus or beet by-product, it is more economical to use higher moisture content fiber mass as the wet material. After the mixture of wet and dry materials have been fluid bed dried (which can be done with air at a more moderate temperature than is needed with flat bed dryers (e.g., room temperature air with low RH may be used, as well as might heated air). A flash drier may also be used alternatively or in combination with a fluid bed drier to effect moisture reduction from the citrus or beet by-product prior to produce a functional dry product. It would be necessary, of course, to control the dwell time in the flash drier to effect the appropriate amount of moisture reduction and prevent burning. These steps may be provided by the primary or source manufacturer, or the product may be provided to an intermediate consumer who will perform this drying step to the specification of the process that is intended at that stage.

One aspect of the drying process is useful for the drying of any expanded cellulose products, especially for the drying of highly refined cellulose fibers and particles that have been extremely difficult or expensive to dry. Those products have been successfully dried primarily only with freeze drying as a commercially viable process. That process is expensive and energy intense. A method according to the present invention for the drying of any expanded cellulose fiber or particle product comprises drying an expanded cellulose product by providing a first mass of expanded cellulose fiber product having a first moisture content as a weight of water per weight of fiber solids; providing a second mass of expanded cellulose fiber product having a second moisture content as a weight of water per weight of fiber solids, the second moisture content being at least 20% less than said first moisture content; combining said first mass of expanded cellulose fiber product and said second mass of expanded cellulose product to form a combined mass; drying said combined mass in a drying environment to form a dried combined mass. The method may have the dried combined mass dried to a moisture content of less than 20, less than 10, less than 8, less than 5 or less than 3H₂O/g fiber mass. The method, by way of non-limiting examples, may use drying environments selected from the group consisting of, flash driers, fluid bed driers and combinations thereof.

The rehydration and shearing (particularly high shearing at levels of at least 10,000 sec⁻¹, preferably at least 15,000 sec⁻¹, more often, greater than 20,000, greater than 30,000, greater than 40,000, and conveniently more than 50,000 sec⁻¹(which is the actual shearing rate used in some of the examples) of the dry fiber product enables the resultant sheared fiber to retain more moisture and to retain moisture more strongly. It has been noted in the use of materials according to the practice of the invention that when the fiber products of the invention are rehydrated, the water activity level of rehydrated fiber is reduced in the fiber (and the fiber present in a further composition) as compared to free water that would be added to the further composition, such as a food product. The food products that result from cooking with 0.1 to 50% by weight of the HRC fiber product of the invention present has been found to be highly acceptable to sensory (crust character, flavor/aroma, grain/texture, taste, odor, and freshness, especially for mixes, frozen foods, baked products, meat products and most particularly for bakery goods, bakery products, and meat products) tests on the products. Importantly, the products maintain their taste and mouth feel qualities longer because of the higher moisture retention. The high water absorbency and well dispersed nature of the product also lends itself to be an efficient thickening agent/suspending agent in paints, salad dressings, processed cheeses, sauces, dairy products, meat products, and other food products.

Donuts, breads, pastry and other flour products that are deemed freshest when they are moist, tend to retain the moisture and their sensory characteristics compatible with freshness longer with the inclusion of these fibers. In bakery products, the loaf volume maintains the same with the addition of the product of the present invention.

In another embodiment, the HRC products of the present invention possess a WRC and ORC that are at least as good as or even better than prior art products (including the Chen product) with regard to the water retention characteristics and the strength of that retention. This is true even though the products of the present invention may have a higher lignin concentration than products made using conventional processes and are dried (and the same amount as the Lundberg patents products). It is assumed that the lignin which is present has been substantially inactivated to a sufficient degree so that the undesirable clumping does not subsequently occur. Another reason for these improved properties may be due to a porous network structure that is present in the HRC products of the present invention, but is lost in prior art products due to high concentration soaking in NaOH, and which may be slightly reduced even with the mild NaOH solutions used by the Lundberg patents.

A number of unexpected properties and benefits have been provided by the highly refined cellulose microfiber product of the present invention derived from parenchymal cell material. These products are sometimes referred to herein as “exclusively parenchymal cell wall structures.” This is indicative of the fact that the majority source of the material comes from the cell structures of the plants that are parenchymal cells. As noted earlier, the HRC microfibers of the invention are not produced by mild treatment of the leaves, stems, etc. of the plants (which are not only parenchymal cell wall structures, but have much more substantial cell structures). This does not mean that any source of citrus or beet cells and fibers used in the practice of the present invention must be purified to provide only the parenchymal cells. The relative presence of the more substantive cells from leaves and stems will cause approximately that relative proportion of cell or fiber material to remain as less effective material or even material that is not converted to HRC, but will act more in the nature of fill for the improved HRC microfibers of the present invention. It may be desirable in some circumstances to allow significant portions of the more substantive cells and fibers to remain or even to blend the HRC (citrus or beet parenchyma based) product of the present invention with HRC fibers of the prior art to obtain particularly desired properties intermediate those of the present invention and those of the prior art. In the primary manufacturing process of the invention (that is, the process wherein the cells that have essentially only parenchymal cell walls are converted to HRC microfibers or particles according to the mild treatment process of the present invention), the more substantive cells and fibers may be present in weight proportions of up to fifty percent (50%). It is preferred that lower concentrations of the more substantive fibers are present so as to better obtain the benefit of the properties of the HRC fibers of the present invention, so that proportions of cells having exclusively parenchymal cell walls in the batch or flow stream entering the refining process stream constitute at least 50%, at least 60%, at least 70%, at least 80%, at least 90%, at least 95%, at least 97%, at least 98%, at least 99% or preferable about 100% of the fibrous or cellular material added to the refining flow stream. The final fiber product should also contain approximately like proportions of the HRC product of the present invention with regard to other HRC additives or fiber additives.

Among the unexpected properties and benefits of the HRC materials of the present invention derived from the mild refinement of cells and fiber from citrus and beet by-product are the fact of the HRC fibers, the stability of HRC fibers from parenchymal cells, the high water retention properties, the strength of the water retention properties of the fibers, the ability of the HRC fibers to retain water (moisture) even when heated, the ability of the HRC fibers to retain water (moisture) on storage, and the ability of the HRC fibers to retain moisture in food stuff without promoting degradation, deterioration or spoilage of the food as compared to food stuff with similar concentrations of moisture present in the product that is not bound by HRC fibers. The ability of the fiber materials of the present invention to retard moisture migration is also part of the benefit. This retarded water migration and water activity of water retained or absorbed by the fibers of the invention may be related to the previously discussed binding activity and binding strength of water by the fiber. As the moisture is retained away from other ingredients that are more subject to moisture-based deterioration, the materials of the invention provide significant benefits in this regard. These benefits can be particularly seen in food products (including baked goods such as breads, pastries, bars, loaves, cakes, cookies, pies, fillings, casseroles, protein salads (e.g., tuna salads, chicken salads), cereals, crackers, meats, processed dairy products, processed cheese, entrees and the like) that are stored as finished products either frozen, refrigerated, cooked, or at room temperature in packaging. The HRC fiber of the present invention may be provided as part of a package mix that can be used by the consumer, with the HRC fibers remaining in the final product to provide the benefits of the invention in the product finished (baked or cooked) by the consumer. The HRC fiber materials of the present invention provide other physical property modifying capabilities in the practice of the invention. For example, the fibers can provide thickening properties, assist in suspending or dispersing other materials within a composition, and the like. These properties are especially present in HRC fibers of the invention provided from sugar beets.

The percentage of fiber in the final product that is desirable to provide identifiable benefits is as low as 0.01% or 0.05% or 0.1% of the total dry weight of the final product. The HRC fiber product of the invention may be used as from 0.05 to 50% by weight of the dry weight of the product, 0.5 to 40%, 1 to 40%, 1 to 30%, 1 to 25%, 1 to 20%, 1 to 15%, 1 to 10%, and 2 to 20% by weight of the dry weight of the final product.

An unexpected property is for the finished dried product to have a viscosity in a 1% solution of 1000-300,000 centipoise at 0.5 rpms when measured using a Brookfield LVDV++ viscometer (Middleboro, Mass.). An additional unexpected property is for the end processed product to have similar rheology curves as other common hydrocolloids, such as xanthan gum. The expanded fiber products of the invention are highly effective and environmentally safe viscosity enhancers. In addition, they are quite useful in edible products, in addition to the functional benefits they add to edible products such as beverages, cheeses, baked goods, liquid and semi-liquid products (stews, soups, etc.).

### EXAMPLE 1

A reduced fat shortening was made by adding Citri-Fi™ 200 FG citrus fiber coprocessed with guar gum from Fiberstar, Inc., water, and vegetable shortening. The water level used was both three and six times the weight of Citri-Fi™ and one half of the shortening was replaced with citrus fiber and water combination. Test 1 contained 100% vegetable shortening. Test 2 contained shortening at 50% and the balance being Citri-Fi™ 200 FG (citrus fiber, guar gum) and water at 6 times the weight of fiber. Test 3 contained shortening at 50% and the balance being Citri-Fi™ 200 FG (citrus fiber, guar gum) and water at 3 times the weight of fiber. All tests were conducted at 75 F with five replicates. The spreadability of the spreads were evaluated using a texture analyzer available from Texture Technologies with a spreadibility rig (TA-425 TTC) to measure the cohesive and adhesive forces of the spreads. The test results are shown in Table 1.

TABLE 1
Cohesive and adhesive forces as measured by a texture
analyzer of a 100% vegetable shortening compared to
50% shortening and balance being Citri-Fi ™ 200 FG
(citrus fiber, guar gum) and water at 6 times the fiber
weight (Test 2) and 3 times the fiber weight (Test 3).

| | Cohesive force | Adhesive force |
|---|---|---|
| Test Number | (g/mm) | (g/mm) |
| Test 1 | 1555.89^{A, b} | −1137.96^{a} |
| Test 2 | 1353.1^{a} | −1061.1^{a} |
| Test 3 | 1736.2^{b} | −1428.49^{b} |

A & B: Denote groupings that are not statistically different from each other.

The spreadability results from Table 1 show that a 50% shortening spread can be made with very similar spreadability to a 100% shortening product. And the adhesive and cohesive forces can be adjusted depending on the amount of water used along with the citrus fiber. In this example, if water is used at three times the weight of the citrus fiber, guar gum, then the spread had more adhesive and cohesive forces and was more firm. Whereas if water is used at six times the weight of the citrus fiber, guar gum, then the spread had less cohesive and adhesive forces and was slightly less firm.

### EXAMPLE 2

Another test was conducted by adding Citri-Fi™ 200 FG (citrus fiber, guar gum), water, to a low trans roll-in, commonly used in the production of Danish, available from Bunge. Once again various water levels were used to evaluate the differences of water levels but another variable of the amount of roll-in replaced was also evaluated. The amount of roll-in replaced was 33% and 50%. Once again the cohesive and adhesive forces were measured using a texture analyzer. Test 4 contained the low trans roll in at 100%. Test 5 contained the low trans roll in at 66% and the remaining being fiber and water at six times its weight. Test 6 contained the low trans roll at 50% and the remaining being fiber and water at 3 times the weight of fiber. Test 7 contained low trans roll in 50% and the remaining being fiber and water at 6 times the weight of fiber. The test results are shown in Table 2.

TABLE 2
Cohesive and adhesive forces as measured by a texture analyzer of
control low trans roll in and reduced fat low trans roll-in spread.
Test 4 contained the low trans roll in at 100%. Test 5 contained
the low trans roll in at 66% and the remaining being fiber and water
at six times its weight. Test 6 contained the low trans roll at 50%
and the remaining being fiber and water at 3 times the weight of
fiber. Test 7 contained low trans roll in 50% and the remaining
being fiber and water at 6 times the weight of fiber.

| | | Adhesive force |
|---|---|---|
| Test Number | Cohesive force (g/mm) | (g/mm) |
| Test 4 | 1295.88^{a} | −1092.29^{a} |
| Test 5 | 1357.79^{a} | −1120.43^{a} |
| Test 6 | 2135.99^{b} | −1899.33^{b} |
| Test 7 | 1803.58^{c} | −1687.1^{c} |

Superscript groupings with common letters denote groupings that are not statistically different from each other.

The results from this testing suggests that with the low trans roll in product, using water at six times the weight of Citri-Fi™ 200 FG (citrus fiber, guar gum) was effective at making a product with similar cohesive and adhesive forces when doing a 33% roll-in replacement, however, at the higher replacement level of 50%, the roll-in was considerably more firm when water was used at either 6 or 3 times the weight of fiber. These results would indicate that to attain a similar spreadibility for this product, a higher water level could be used.

### EXAMPLE 3

Another round of tests was conducted using a margarine roll in commonly used in the production of Danish. This time a straight water level of six times the weight of Citri-Fi™ 200 FG (citrus fiber, guar gum) was used and two levels of roll-in replacement were evaluated, namely, 50% and 33% replacement. The cohesive and adhesive forces were measured using the same texture analyzer and rigging as in examples one and two. Test 8 contained 100% margarine roll-in. Test 9 contained margarine roll-in at 66% and the balance being Citri-Fi™ 200 FG (citrus fiber, guar gum) and water at 6 times the weight of fiber. Test 10 contained margarine roll-in at 50% and the balance being Citri-Fi™ 200 FG (citrus fiber, guar gum) and water at 6 times the weight of fiber. The test results are shown in Table 3.

TABLE 3
Cohesive and adhesive forces as measured by a texture analyzer of
control margarine roll in and reduced fat margarine roll-in spread.
Test 8 contained 100% margarine roll-in. Test 9 contained
margarine roll-in at 66% and the balance being Citri-
Fi ™ 200 FG (citrus fiber, guar gum) and water at 6
times the weight of fiber. Test 10 contained margarine roll-in
at 50% and the balance being Citri-Fi ™ 200 FG
(citrus fiber, guar gum) and water at 6 times the weight of fiber.

| | Cohesive force | Adhesive force |
|---|---|---|
| Test Number | (g/mm) | (g/mm) |
| Test 8 | 1433.12^{a} | −1184.75^{a} |
| Test 9 | 998.48^{b} | −865.97^{b} |
| Test 10 | 1084.98^{b} | −986.34^{b} |

The test results shown in Table 3 suggest that with this margarine roll-in, a water level of 6 times the weight of fiber may be higher than what is needed to make a reduced fat roll-in with equivalent spreadability compared the full fat control.

### EXAMPLE 4

In Example 1 and in Example 2 we showed that the by adding water at three times the weight of the Citri-Fi™ 200 FG (citrus fiber, guar gum) can make the reduced fat spread more thick compared to the control spread. However, an alternative way to make a more cohesive and adhesive texture is to start with a fat that has a harder texture and to add the 6 times water and fiber to this starting mixture. In this example, a Swede Gold shortening was used along with Citri-Fi™ 200 FG (citrus fiber, guar gum) and water at 6 times the fiber weight. The texture of this combination was compared to the control roll-in as shown in Test 8. The spreadability of the spreads were evaluated using a texture analyzer available from Texture Technologies with a spreadibility rig (TA-425 TTC) to measure the cohesive and adhesive forces of the spreads.

TABLE 4
Cohesive and adhesive forces as measured by a texture analyzer
of control margarine roll in and reduced fat margarine roll-in spread.
Test 8 contained 100% margarine roll-in. Test 11 contained a hard
fat roll-in that was reduced by 50% with Citri-Fi ™ 200 FG
(citrus fiber, guar gum) and water at 6 times the fiber weight.

| | Cohesive force | Adhesive force |
|---|---|---|
| Test Number | (g/mm) | (g/mm) |
| Test 8 | 1433.12^{a} | −1184.75^{a} |
| Test 11 | 2159.61^{b} | −1731.63^{b} |

### EXAMPLE 5

A control Danish made with 100% margarine roll-in was compared to a Danish made with a reduced fat roll-in that was prepared and compared to a 66% roll-in and balance being Citri-Fi™ 200 FG (citrus fiber and guar gum). The water level used was six times the weight of the fiber. Roll in is typically used in a Danish to produce the flaky and layered texture that is desired for a Danish or croissant. Thus, the test with the reduced fat roll in to see if the layered texture and flakyiness could be maintained when the roll-in had a percentage replaced with Citri-Fi™ 200 FG (citrus fiber and guar gum) and water. The following formula was used for the control and reduced fat Danish.

TABLE 5
Formula used in the production of a control
and reduced fat roll-in Danish.

| | | 50% |
|---|---|---|
| | Control | Reduced |
| Item Name | (lbs) | Shortening |
| Danish Base | 100.00 | 100.00 |
| Eggs, Whole | 8.04 | 8.04 |
| Water | 34.29 | 34.29 |
| Yeast | 3.52 | 3.52 |
| Roll In | 8.71 | 5.81 |
| Water | 0.00 | 2.49 |
| Citri-Fi ™ 200 FG | 0.00 | 0.42 |

After baking, the eating qualities in terms of taste, texture, flakiness, of both the control and reduced fat Danish were noted to be near identical to each other, which suggests that the Citri-Fi™ 200 FG (citrus fiber and guar gum) and additional water in the reduced fat roll-in can maintain the integrity of the full fat roll-in to provide a layered and flaky texture.

### EXAMPLE 6

### Reduced Fat Cake

Citri-Fi™ 100 citrus fiber from Fiberstar, Inc. was used in testing a 50% reduced fat shortening cake formula. The amount of Citri-Fi™ 100 citrus fiber used was 0.125 times the weight of shortening removed from the formula and the amount of water was 7 times the weight of Citri-Fi™ 100 citrus fiber. The nutritional analysis for the control and test cake formula was generated using Genesis software from Esha Research (Salem, Oreg.). The cake was made according to the formula shown in Table 1:

| | Control | Reduced |
|---|---|---|
| Ingredient | formula | shortening |
| Step 1 | | |
| granulated sugar | 110.1 | 110.1 |
| cake shortening | 52.9 | 26.5 |
| Citri-Fi ™ 100 | 0 | 5.3 |
| water | 0 | 15.9 |
| Step 2 | | |
| cake flour | 100 | 100 |
| non fat dry milk | 10.1 | 10.1 |
| baking powder | 7.6 | 7.6 |
| soda | 0.7 | 0.7 |
| salt | 3.7 | 3.7 |
| pre-gel wheat | 4.9 | 4.9 |
| starch | | |
| Step 3 | | |
| water | 70 | 70 |
| Step 4 | | |
| whole eggs | 89.9 | 89.9 |
| vanilla flavor | 2.5 | 2.5 |
| water | 19.9 | 19.9 |
| TOTAL | 472.3 | 467.1 |

Here is the mixing and baking procedure for the cakes.
1. Combine fiber, water, shortening, and sugar in the mixing bowl, and mix on low for 2 minutes with a flat paddle.
2. Add: cake flour, sugar, dried milk, baking powder, baking soda, salt, and pre gelatinized wheat starch.
3. Gradually add the water in step 3, and mix on low for 4 minutes. Scrape the bowl.
4. Combine eggs, vanilla flavor, and water then add them in two parts.
5. Mix for 2 minutes after each half addition from step 4 and scrape after each addition.
6. Make sure that the mix is properly combined, and if it's not then mix it a few more minutes.
7. Scale 580 grams of batter in each pan.
8. Bake at 360 degrees Fahrenheit for 29 minutes.

The following table shows the nutritional information for the control and test cakes, which shows the reduced trans and saturated fat levels.

Cake Nutritional Information

| Nutrient | Control | Test |
|---|---|---|
| Gram weight, g | 100 | 100 |
| Calories, kcal | 308 | 273 |
| Calories from Fat | 123 | 75.6 |
| Protein, g | 4.64 | 4.99 |
| Carbohydrates, g | 42.9 | 46.3 |
| Dietary Fiber, g | 0.57 | 1.5 |
| Total Sugars, g | 25.8 | 27.7 |
| Total Fat, g | 13.6 | 8.4 |
| Saturated Fat, g | 3.18 | 1.98 |
| Trans Fatty Acid, g | 3.4 | 1.79 |

This table shows the physical properties of the cakes in terms of the cakes height and volume, which shows the test cake with reduced fat and Citri-Fi™ 100 citrus fiber had increased height and volume.

| | height | volume |
|---|---|---|
| Cake | (mm) | (mm\hat{ }3) |
| Control | 38.2 | 1386 |
| Test | 41.6 | 1510 |

Because shortening has a softening effect in bakery products and allows them to stay fresher longer, these results show that Citri-Fi™ citrus fiber can be used to replace fat, shortening, and oil and maintain a product with similar eating qualities to the control.

### EXAMPLE 7

### Reduced Fat Bread

Bread was made according to the formula shown in the following table where 100% of the shortening was placed in the formula. Citri-Fi™ 200 citrus fiber and guar gum was used in this test.

| | Control | 50% fat |
|---|---|---|
| Item Name | Formula | Formula |
| Flour | 1000 | 1000 |
| Water, municipal | 620 | 620 |
| granulated sugar | 90 | 90 |
| extra water | 0 | 90 |
| compressed yeast | 70 | 70 |
| Shortening | 60 | 0 |
| wheat bran | 30 | 30 |
| Salt | 22 | 22 |
| Citri-Fi ™ 200 citrus fiber | 0 | 15 |
| and guar gum | | |
| Calcium proprionate | 4 | 4 |
| Sodium stearyol | 2 | 2 |
| lactylate | | |

Here is the nutritional information for the bread.

| Nutrient | Control | Test |
|---|---|---|
| Gram weight, | 100 | 100 |
| grams | | |
| Calories, kcal | 270 | 260 |
| Protein, g | 9 | 9 |
| Carbohydrates, g | 55 | 55 |
| Dietary Fiber, g | 2 | 2 |
| Total Sugars, g | 6 | 6 |
| Total Fat, g | 2 | 1 |
| Saturated Fat, g | 0 | 0 |
| Trans Fatty Acid, g | 0.5 | 0 |

The loaf volume, eating characteristics, and grain for both breads came out looking nearly identical to each other. To the touch the 100% less shortening bread was significantly softer than the control.

### EXAMPLE 8

### Reduced Fat Sweet Rolls

Citri-Fi™ 100 citrus fiber was used to make a 50% reduced fat shortening in a sweet roll according the formula in the following table.

| | | 50% reduced |
|---|---|---|
| Item Name | Control | Shortening |
| Flour, all purpose | 500 | 500 |
| Flour, pastry | 500 | 500 |
| Shortening | 240 | 120 |
| Eggs, whole | 240 | 240 |
| Milk, whole, dry pwd | 60 | 60 |
| Water, municipal | 450 | 450 |
| Yeast, compressed | 60 | 60 |
| Salt, table | 17.5 | 17.5 |
| Sugar, granulated | 240 | 240 |
| Citri-Fi ™ 100 citrus | 0 | 34.8 |
| fiber | | |
| Water, municipal | 0 | 139 |

Here is the nutritional information for the sweet roll formula, which was generated using Genesis software.

Sweet Roll Nutritionals

| | | 50% reduced | |
|---|---|---|---|
| Nutrients | Control | Shortening | Units |
| Gram Weight | 100 | 100 | g |
| Calories | 313.56 | 265.08 | kcal |
| Calories from Fat | 113.23 | 65.76 | kcal |
| Calories from SatFat | 31.41 | 18.81 | kcal |
| Protein | 7.5 | 7.43 | g |
| Carbohydrates | 44.26 | 44.46 | g |
| Dietary Fiber | 2.88 | 3.91 | g |
| Soluble Fiber | 0.3 | 0.84 | g |
| Total Sugars | 11.77 | 12.04 | g |
| Fat | 12.74 | 7.39 | g |
| Saturated Fat | 3.49 | 2.09 | g |
| Trans Fatty Acid | 3.22 | 1.58 | g |

The physical appearance of the sweet rolls and the eating qualities in terms of taste, texture, and freshness throughout the products shelf life were noted to be very similar to each other.

### EXAMPLE 9

### Reduced Fat Muffins

In addition to making a reduced fat shortening, roll-in, or spread, expanded cell wall materials can also be used to reduced the fat in an oil. The resultant reduced fat oil has a similar consistency as a standard oil and when this is added into a formula, the resultant product has very similar eating qualities compared to the full fat oil. In this experiment, Citri-Fi™ 100 citrus fiber was used to reduce oil in a muffin formula. A Multi-Foods muffin mix (# 44812) was used in this testing and the control formula was followed according to the instructions on the bag. The formula used for the muffins is shown below:

| | Control | Test |
|---|---|---|
| Ingredient Name | Formula | Formula |
| Multi Foods cake base 44812 | 100 | 100 |
| Eggs, whole | 35 | 35 |
| Oil, veg, pure | 30 | 15 |
| Water, municipal | 22 | 22 |
| Citri-Fi ™ 100 citrus fiber | 0 | 3 |
| Blueberries, fresh, ea | 30 | 30 |
| Water, municipal | 0 | 18 |

The muffins made according to the formula above were noted to have very similar volume and eating qualities that would be difficult for a person to distinguish one from the other. Here is the nutritional information for the reduced fat muffins, which was calculated using Genesis software.

Muffin Nutritionals per 100 g

| | | 50% reduced | |
|---|---|---|---|
| Nutrients | Control | shortening | Units |
| Gram Weight | 100 | 100 | g |
| Calories | 330 | 270 | kcal |
| Protein | 4 | 4 | g |
| Carbohydrates | 40 | 41 | g |
| Dietary Fiber | 1 | 2 | g |
| Total Sugars | 24 | 24 | g |
| Fat | 18 | 11 | g |
| Saturated Fat | 3 | 2 | g |
| Trans Fatty Acid | 0 | 0 | g |

1. A composition of matter used for an ingredient in cooking comprising 1-30% by weight of highly refined cellulose fiber, 20-85% by weight animal consumable oils or fats and 5-40% by weight of water.

2. The composition of matter of claim 1 consisting essentially of 1-30% by weight of highly refined cellulose fiber 20-85% by weight animal consumable oils or fats and 5-40% by weight of water.

3. The composition of claim 1 consisting of 1-30% by weight of highly refined cellulose fiber derived 20-85% by weight animal consumable oils or fats and 5-40% by weight of water.

4. The composition of claim 1 further comprising from 1-40% by weight of sugar.

5. The composition of claim 1 consisting essentially of 1-40% by weight of sugar, 1-30% by weight of highly refined cellulose fiber 20-85% by weight animal consumable oils or fats and 5-40% by weight of water.

6. The composition of claim 1 consisting of 1-40% by weight of sugar, 1-30% by weight of highly refined cellulose fiber 20-85% by weight animal consumable oils or fats and 5-40% by weight of water.

7. A method of providing a mass for baking edible consumables comprising adding the composition of claim 1 to edible consumable materials to form a cookable mass and cooking the cookable mass.

8. A method of providing a mass for baking edible consumables comprising adding the composition of claim 2 to edible consumable materials to form a cookable mass and cooking the cookable mass.

9. A method of providing a mass for baking edible consumables comprising adding the composition of claim 3 to edible consumable materials to form a cookable mass and cooking the cookable mass.

10. A method of providing a mass for baking edible consumables comprising adding the composition of claim 4 to edible consumable materials to form a cookable mass and cooking the cookable mass.

11. A method of providing a mass for baking edible consumables comprising adding the composition of claim 5 to edible consumable materials to form a cookable mass and cooking the cookable mass.

12. A method of providing a mass for baking edible consumables comprising adding the composition of claim 6 to edible consumable materials to form a cookable mass and cooking the cookable mass.

13. The method of claim 7 wherein the composition is formed by first combining the highly refined cellulose fiber and water to form hydrated highly refined cellulose fiber, and combining the hydrated cellulose fiber with additional ingredients.

14. The method of claim 8 wherein the composition is formed by first combining the highly refined cellulose fiber and water to form hydrated highly refined cellulose fiber, and combining the hydrated cellulose fiber with at least one of fats and oil.

15. The method of claim 9 wherein the composition is formed by first combining the highly refined cellulose fiber and water to form hydrated highly refined cellulose fiber, and combining the hydrated cellulose fiber with 20-85% by weight animal consumable oils or fats.

16. A composition according to claim 1 that is useful as a shortening and retains its own shape at 10° C.

17. A composition according to claim 2 that is useful as a shortening and retains its own shape at 10° C.

18. A composition according to claim 3 that is useful as a shortening and retains its own shape at 10° C.

19. A composition according to claim 2 that is useful as a shortening and retains its own shape at 10° C.

20. The composition of claim 1 further comprising from 0.5-20% by weight of emulsifiers.

21. The composition of claim 1 used to in a salad dressing or sauce as an oil replacement.

22. The composition of claim 1 in a dairy product or imitation dairy product as a fat replacement.

23. The composition of claim 1 in a fried product as a replacement for oil.

24. The composition of claim 1 in a frozen food product.

25. The composition of claim 1 in an extruded food product.

26. The composition of claim 1 wherein the refined cellulose material comprises high parenchymal cell wall derived cellulosic product.

27. The composition of claim 2 wherein the refined cellulose material comprises high parenchymal cell wall derived cellulosic product.
